(19) United States
(12) Patent Application Publication
(10) Pub. No.: US 2024/0370840 A1
(43) Pub. Date: Nov. 7, 2024

(54) Method and system for enabling bank accounts owners to allocate money to recipients for making cardless withdrawals from automated teller machines ATM

(71) Applicant: Meir Dahan, Tveria (IL)

(72) Inventor: Meir Dahan, Tveria (IL)

(21) Appl. No.: 18/143,068

(22) Filed: May 4, 2023

(51) Int. Cl. G06Q 20/10; G06Q 20/08; G06Q 20/40

(52) U.S. Cl. CPC G06Q 20/1085; G06Q 20/0855; G06Q 20/40

(57) ABSTRACT

A method and system for enabling a bank account owner to allocate a certain amount of money to a recipient for making cardless withdrawals form automated teller machine ATM, that includes the receiving by servers the allocation request from a computing device of the owner by means of a computer application, the cardless withdrawals require input in to the automated teller machine ATM of a specific mobile phone number that the owner specified in the request, receiving by the automated teller machine ATM the input of the mobile number, generating a one-time password to be input in to the automated teller machine ATM, and transmitting this password to that mobile number, receiving by the automated teller machine ATM the input of that password, verifying that the password that was input in to the automated teller machine ATM matches the generated password, and authorizing and enabling the withdrawal.

### TECHNICAL FIELD

The present invention refers to a method and system for authorizing and enabling cardless withdrawals of money from automated teller machines by third parties identified by mobile phone numbers.

### BACKGROUND ART

In many cases people prefer to receive money in cash instead of receiving it to their bank account. This does not mean that it is an illegal receipt of money or a desire to avoid reporting to the tax authorities, rather, this need sometimes stems from an approach that advocates personal freedom not to be tracked and also from a desire to avoid the need to give legitimate explanations for receiving funds legally that there was no legal obligation to report them, which involves in expense and trouble, and to avoid the need to give such explanations there is interest in receiving sums of money in cash without leaving digital traces of the receipt of that money. In many cases, the person who supposed to receive the money is in a distant place from the person who supposed to give the money, so handing over money in cash from hand to hand is not practical. The present invention provides a good solution to this problem, as well as other problems of transferring money to friends or family members who have lost their wallet and needs urgent cash when they are in distance.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a flow chart of the method 200.

FIG. 2 is a block diagram that depicts the system (200S) with the servers (32), the processing devices (31), the automated teller machine ATM (201), the computing device (33), the mobile phone (35) and the computer application (34).

### THE INVENTION

The main objective of the present invention is to provide a computer-implemented method (200) for enabling an owner of a bank account to allocate a certain amount of money to a third party recipient, such that the third party recipient is authorized to (cardless) withdraw in cash the allocated certain amount of money from automated teller machine ATM (201). The third party recipient is able and authorized to make the cardless withdrawal from the automated teller machine ATM by input a specific mobile phone number that the owner sets in the request for allocation the certain amount of money from the automated teller machine ATM.

The term “bank account” in this disclosure and in the claims means any kind of account that enables the owner to withdraw cash from automated teller machines ATM with or without a card.

The method is performed by processing devices (31) running on one or more servers (32) and one or more automated teller machines ATM (201) that are programed to be functioned and to be used for executing the method.

The method includes the following steps and means:

A. Step reference number (200A): this step is optionally, but in any case the owner should use the relevant computer application (which is likely to run under the consent of the bank): Receiving, by the one or more servers (32) from a computing device (33) of the bank account owner, a request to login to a computer application (34) (in which the bank account owner may have a profile). The term “login” in this disclosure and in the claims means also to “logon” and therefore the request to login to the computer application may include the need to provide one or more security feature submitted by the owner of the bank account such as a password, a PIN, or a biometric as it is customary in this filed.

The term “computing device” (33) in this disclosure and in the claims means any kind of computer that includes an internet access, such as a smartphone, a mobile phone, a tablet, laptop, desktop and the like. The term “computer application” (34) literally means computer software applications that enable users and owners of bank accounts to operate their account. The term “the computing device (33) of the owner” means the device that he uses for entering the computer application.

B. Step reference number (200B): this step is optionally, but in any case the owner should insert some identification to ensure that it is he that make the request): Granting, by the one or more servers, authorization to said computing device of the owner to access to the computer application. The access to the computer application (or the completion of the request in step reference number 200C) may be in response to verifying that the submitted security feature match the profile security feature stored in the user profile in the server that run the computer application, as customary done when a person wishes to login to his account by a computer or to wire money to a third person.

C. Step reference number (200C): Receiving, by the one or more servers, a request from the computing device of the bank account owner, by means of said computer application, to allocate the certain amount of money to the third party recipient so that he become authorized and able to make the cardless withdrawal in cash of the allocated certain amount of money from an automated teller machine ATM upon entering said specific mobile phone number at the relevant automated teller machine ATM. It is possible that the recipient will withdraw the money in a few withdrawals that in total are limited to that certain amount of money. Each cardless withdrawal requires an input in to the automated teller machine ATM of the specific mobile phone number that the bank account owner specified as part of the request to allocate the amount of money to the third party recipient.

The computer application enables to set the amount of money that the owner wants to enable that third person to withdraw in cash from his bank account (by using the ATM) and the specific mobile phone number of that recipient (no need to give or get specific passwords in this stage for executing the withdrawal). The bank account owner may need to add nothing beyond that. The owner should enter to the computer application the phone number of the recipient and the certain amount of money (and maybe to tap “Done” or “Send”) and by that he sends the request. The computer application may be designed in a way that it will enable the owner to determine whether the allocation of said money is reversible or irreversible. “Reversible” means that that the request to enable the withdrawals limited to the certain amount of money can be canceled as to the part of the certain amount of money that yet was not withdrawn at thae moment of cancelation of the request, and determining by the one or more servers that said request is reversible; “Irreversible” means that the request to enable the withdrawal in cash of the certain amount of money cannot be canceled at all, and determining by the one or more servers that said request is irreversible. So, when recipient receives the message that the certain amount is irreversible he can see it as a certain amount that fully paid to him and not on a condition.

It is understood that the owner should enter a specific mobile phone number that is possessed by the third party recipient that he wishes to enable him to make the cardless withdrawal (or with access to that specific mobile phone number), and the owner knows that the method includes the step (the need) of the recipient to enter OTP phone verification that will be sent as SMS for example to the mobile phone (35) of the recipient using that phone number. When recipient wishes to get money without tracing he can buy a sim without providing identification, which is legal at many democratic countries as part of the personal freedom.

The computer application may be designed in a way that it will enable the owner to determine whether the allocation of said money can be canceled (reversible allocation) or whether from the moment he approves the allocation then it cannot be returned (irreversible allocation). Also, it is possible and desirable that, immediately after the allocation is made, the system that operates this method will send a message to the mobile phone number of the recipient informing him that the owner has allocated to him that certain amount of money and that the allocation can be canceled (revisable), or cannot be canceled (irreversible), and it is possible that the message (SMS) will include a period of time within he must withdraw the money otherwise the allocation will be canceled automatically (this for cases in which the recipient lost his sim with that mobile phone number for example).

D. Step reference number (200D): Receiving, by the automated teller machine ATM, (an entry) the input of the specific mobile phone number that is required in order for enabling (authorizing) the cardless withdrawal in cash. In this step, when the recipient wishes to withdraw in cash the money then he needs to enter his specific mobile phone number into the automated teller machine ATM. The existing automated teller machines ATM are fit for this mission if updating their program operation, such as, by adding an option to press a button or to tap on their touch screens to select option to withdraw by phone number for example.

E. Step reference number (200E): In response to the input of the specific mobile phone number in to the automated teller machine ATM, the one or more servers generate and transmit to the specific mobile phone number (to the mobile device in which the sim of this number is activated) an SMS or another type of message with the onetime password OTP (similar to phone verification). The fact that the OTP that enables the withdrawal is generated and transmitted a moment of the withdrawal and directly to the recipient is an important part and it is an effective protection mechanism.

F. Step reference number (200F): Receiving, by the automated teller machine ATM, the input of the onetime password (OTP), means that the recipient needs to enter at the automated teller machine ATM the OTP for completing the withdrawal.

G. Step reference number (200G): Verifying, by the one or more servers or by the automated teller machine ATM, that the onetime password (OTP) that was input in to the automated teller machine ATM matches the generated onetime password (OTP). The match can be done for example in the automated teller machine ATM itself (means that the one or more servers send the OTP also the automated teller machine ATM) or on the one or more servers. The verification can be done by comparing the entered OPT with the generated OTP, in the one or more servers, the automated teller machine ATM, or in a database located in the one or more servers.

Before verifying the OTP or before authorizing the cardless withdrawal, it is desirable that the one or more servers will determine whether the withdrawn amount (together with other withdrawals done before) do not exceed the limited certain amount of money.

H. Step reference number (200H): authorizing and enabling, by the one or more servers or by the automated teller machine ATM, the withdrawal in cash upon said verification. In general, authorization means that the automated teller machine ATM enables the withdrawal.

The bank can charge the bank account of the owner for the allocated certain amount at any time and in several ways, for example: in the case of an irrevocable (irreversible) allocation, the bank can charge the bank account of the owner at the moment of the allocation for the entire allocation amount, or lock the allocation amount so that it will no longer be available for use by the bank account owner and will charge the account upon the withdrawals in fact. It is possible to charge the bank account after each withdrawal. The manner and time of the charge can be made in several dates and ways.

In other words, the request to allocate the certain amount of money can be reversible, and in this case the servers or the computer applications enable the bank account owner to cancel the allocation. Another option of the method, the request to allocate the certain amount of money cab be irreversible, and in such case the servers or the computer applications limiting the bank account owner to cancel the allocation (means, that in the regular standard options the owner is disabled from having the option to cancel such irreversible allocation, but he may have the option to do so throng a specific request that will be decided by a representative of the credit card company in a certain special cases). In response to irreversible request, the method may send a message to the specific mobile phone number stating that the allocation of the certain amount of money is irreversible.

The method can be designed to enable the recipient to withdraw a part of the money, and he can withdraw the balance at another time. Also, the method can be designed to enable to include the possibility that in case that several amounts have been assigned (allocated) to the same phone number by several people (bank account owners), then the details of the senders can be displayed on the automated teller machine ATM's display (when inserting the OTP) and the recipient will be given the option to choose from whom to withdraw and how much (with limited to the allocated amount from that person/owner). It is possible and desirable that after each withdrawal, both the bank account owner and the recipient will receive a message from the servers informing them that a withdrawal has been approved for x amount and that the remaining balance for withdrawal is y for example.

Another objective of the present invention is to provide a computer system (200S) for enabling the owner of the bank account to allocate a certain amount of money to a third party recipient, such that the third party recipient is authorized and enabled to (cardless) withdraw in cash the allocated certain amount of money from automated teller machine ATM (201). The third party recipient is able and authorized to make the cardless withdrawal from the automated teller machine ATM by input a specific mobile phone number that the owner sets in the request for allocation the certain amount of money from the automated teller machine ATM. In general the parts of the system (200S) are same to the parts and steps of the method (200) and there is no need to repeat theme.

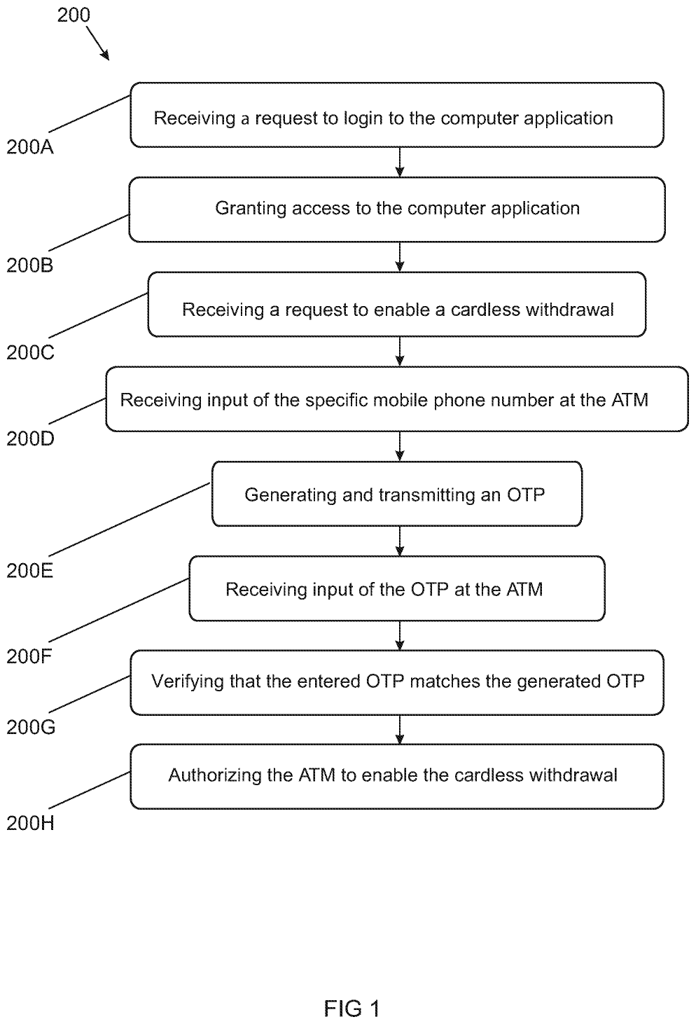

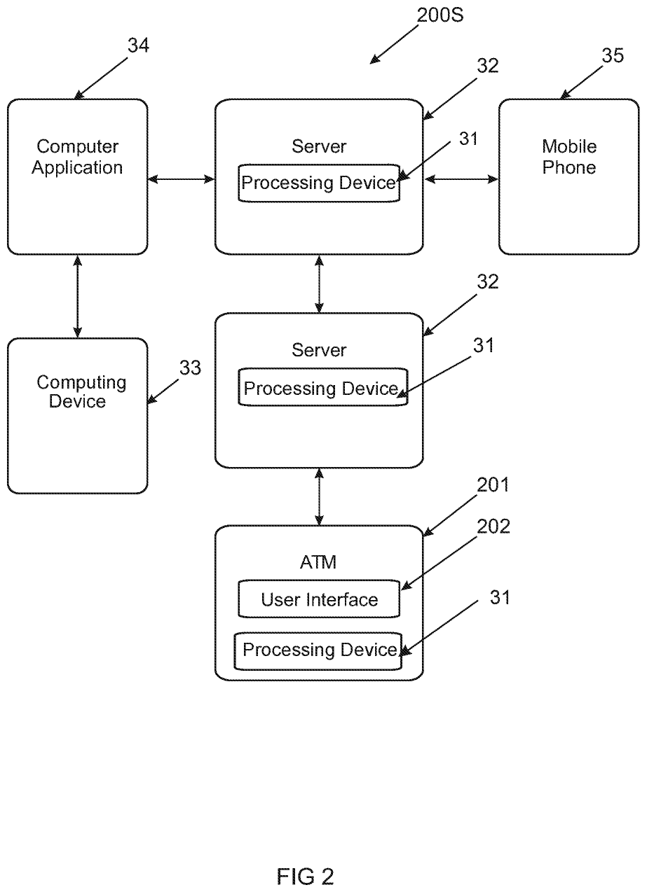

The communications means and methods between the computing devices, the servers, the automated teller machines ATM, the computer application, are known to experts in the field and therefore there is no need to describe them in this disclosure. FIG. 1 is a flow chart of the method 200. FIG. 2 is a block diagram that schematically depicts the system (200S) with the servers (32), the processing devices (31), the automated teller machine ATM (201) with its user interface (202) for entering the specific mobile phone number and the OTP, the computing device (33) of the owner, the mobile phone (35) of the recipient and the computer application (34).

What is claimed is:

1. A computer-implemented method for enabling an owner of a bank account to allocate a certain amount of money to a third party recipient for enabling the third party recipient to make a cardless withdrawal in cash of the allocated certain amount of money from an automated teller machine ATM, the method comprises the following steps:
receiving, by the one or more servers, a request from a computing device of the bank account owner, by means of a computer application, to allocate said amount of money to the third party recipient for enabling the third party recipient to make the cardless withdrawal in cash from the automated teller machine ATM, wherein said cardless withdrawal in cash requires input in to the automated teller machine ATM of a specific mobile phone number that the bank account owner specified as part of the request to allocate said amount of money to said third party recipient;
receiving, by the automated teller machine ATM, the input of said mobile phone number that is required in order to enable the cardless withdrawal in cash;
generating, by the one or more servers, in response to said input of said mobile phone number in to the automated teller machine ATM, a one-time password (OTP) to be input in to the automated teller machine ATM, and transmitting said one-time password (OTP) to said mobile phone number;
receiving, by the automated teller machine ATM, the input of the one-time password (OTP);
verifying, by the one or more servers or by the automated teller machine ATM, that the one-time password (OTP) that was input in to said automated teller machine ATM matches the generated one-time password (OTP); and
authorizing, by the one or more servers or by the automated teller machine ATM, the cardless withdrawal in cash upon said verification.

2. The computer-implemented method of claim 1, wherein said request to allocate said amount of money is reversible, and wherein the method further comprises: enabling, by said one or more servers or said computer application, said bank account owner to cancel said allocation.

3. The computer-implemented method of claim 1, wherein said request to allocate said amount of money is irreversible, and wherein the method further comprises: limiting, by said one or more servers or said computer application, said bank account owner to cancel said allocation.

4. The computer-implemented method of claim 3 that further comprises: generating, by the one or more servers, in response to said irreversible request to allocate said amount of money, a message stating that said allocation of said amount of money is irreversible, and transmitting the message to said mobile phone number.

5. A computer system for enabling an owner of a bank account to allocate a certain amount of money to a third party recipient for enabling the third party recipient to make a cardless withdrawal in cash of the allocated certain amount of money from an automated teller machine ATM, the computer system configured to:
receive, by the one or more servers, a request from a computing device of the bank account owner, by means of a computer application, to allocate said amount of money to the third party recipient for enabling the third party recipient to make the cardless withdrawal in cash from the automated teller machine ATM, wherein the cardless withdrawal in cash requires input in to the automated teller machine ATM of a specific mobile phone number that the bank account owner specified as part of the request to allocate said amount of money to said third party recipient;
receive, by the automated teller machine ATM, the input of said mobile phone number that is required in order to enable the cardless withdrawal in cash;
generate, by the one or more servers, in response to said input of said mobile phone number in to the automated teller machine ATM, a one-time password (OTP) to be input in to the automated teller machine ATM, and transmit said one-time password (OTP) to said mobile phone number;
receive, by the automated teller machine ATM, the input of the one-time password (OTP);
verify, by the one or more servers or by the automated teller machine ATM, that the one-time password (OTP) that was input in to said automated teller machine ATM matches the generated one-time password (OTP); and
authorize, by the one or more servers or by the automated teller machine ATM, the cardless withdrawal in cash upon said verification.

6. The system of claim 5, wherein said request to allocate said amount of money is reversible, and wherein the system further comprises: enable, by said one or more servers or said computer application, said bank account owner to cancel said allocation.

7. The system of claim 5, wherein said request to allocate said amount of money is irreversible, and wherein the system is further comprises: limit, by said one or more servers or said computer application, said bank account owner to cancel said allocation.

8. The system of claim 7 that further comprises: generate, by the one or more servers, in response to said irreversible request to allocate said amount of money, a message stating that said allocation of said amount of money is irreversible, and transmit the message to said mobile phone number.
